(19) United States
(12) Patent Application Publication
(10) Pub. No.: US 2005/0116366 A1
(43) Pub. Date: Jun. 2, 2005

(54) Gas humidifier

(76) Inventors: Yves Danthez, La Norville (FR); Marco Casares, Fresnes (FR)

Correspondence Address: ANTHONY H. HANDAL;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 10/883,560

(22) Filed: Jul. 1, 2004

(30) Foreign Application Priority Data
Jul. 3, 2003 (FR) 03.50293

(51) Int. Cl. B01F 3/04

(52) U.S. Cl. 261/122.1; 261/DIG. 65

(57) ABSTRACT

The invention relates to a gas humidifier including a liquid water vessel (1), an inlet door (4) for injecting gas in the vessel (1) and an outlet door (5) for the gas in the vessel.

According to the invention, the humidifier comprises means for injecting vapour-phased water (6) in the gas, the gas flowing through said means (6), said means (6) containing a diaphragm at least partially immersed in the liquid water (7). Applications to ICP-type atomic emission spectrometry and to atomic absorption spectrometry.

The present invention relates to a gas humidifier, notably for atomic emission spectrometry.

Inductively coupled plasma (ICP) source emission spectrometry is one of the most frequently used atomic emission spectrometry techniques. It enables to determine quantitatively the elementary composition of samples with a sensitivity on the concentrations of elementary species of the order of ppb (parts per billion), possibly ppt (parts per trillion) for certain elements.

This detection limit is, for instance, necessary for the analysis of toxic elements contained in water in order to meet the very low concentration limits allowed.

To reach such a detection limit, it is known to nebulize the sample to be analysed with a nebulizer before introduction in the excitation device. It has been indeed demonstrated that the quality of the detection depends very highly on the way whereof the sample to be analysed is introduced in the excitation device of the emission spectrometer and in particular, of the size distribution of the particles in the excitation device, excitation and ionisation of the larger particles being smaller. Moreover, the introduction of nebulized elements reduces the cooling effect of the plasma observed when injecting a large volume of liquids, which means that more energy is available for the excitation and the ionisation of the particles thereby increasing the detection limit. Generally, the nebulizers implemented are pneumatic nebulizers, which are concentric or tangential.

The elements thus nebulized are then driven into the plasma-supporting gas flow, typically argon. The ICP excitation device which is a very high temperature excitation source (7000-8000 K), vaporises, excites and ionises then the atoms. The luminous radiations emitted by the ion, atom and electron beam coming from the plasma thus created, are sent to a diffraction grid spectrometer for analysis.

Nevertheless, by reason of the geometry of the nebulizer and of the flows of fluids where the nebulization takes place, the nebulizer tends invariably to become plugged when the analyte, i.e. the sample to be analysed, contains a high concentration of salts. It is then known, to prevent the nebulizer from becoming plugged, to humidify the carrier gas. The water-saturated carrier gas then enables to minimise the material deposit at the end of the nebulizer. The gas humidifier represents therefore a pivot element of the introduction system of the sample to be analysed in the excitation device.

The use of a humidifier is associated with the type of analyte and it must therefore be easily accessible by an operator for rapid connection or disconnection to the introduction system. It is also necessary for this humidifier to be situated as close as possible to the nebulizer since the water-saturated gas is only required at the location where the nebulization is situated.

However, the humidification devices of the previous art are generally complex since they consist of a plurality of components. The sourcing and assembly costs of these multiple components influence the production cost of these devices. They are cumbersome and therefore at a distance from the location where the humidified gas is necessary. They are, moreover, difficult to be implemented by an operator.

The object of the present invention is to provide a humidifier simple in its design, very user-friendly and in particular for connection and disconnection to an analysis device, enabling to incorporate vapour-phased water in gases, in particular for atomic emission spectrometry, for instance ICP-type spectrometry.

A particularly interesting advantage of this invention is that the water contained in the vessel is at atmospheric pressure or thereabout, which enables to fill said vessel without stopping the operation of the humidifier. Moreover, as the humidifier operates at atmospheric pressure, there is no pressurised tank in the nebulization gas line, which eliminates any exhaust to atmospheric pressure.

To that effect, the invention relates to a gas humidifier including a liquid water vessel, an inlet door for injecting gas in the vessel and an outlet door for the gas in the vessel.

According to the invention, the humidifier comprises means for injecting vapour-phased water in the gas, the gas flowing through said means, said means containing a diaphragm at least partially immersed in the liquid water.

By “diaphragm” is meant here any porous body, whereof the pores are sufficiently small to prevent the passage of liquid phase water, but large enough to enable the passage of vapour phase water.

In different particular embodiments of the humidifier, each having its own advantages and subject to numerous possible technical combinations:
said diaphragm is the wall of a tube connected to the inlet and outlet doors,
said diaphragm is the wall of a spiral connected to the inlet and outlet doors,
the vessel and the inlet and outlet doors form a single part obtained directly by moulding,
said monobloc part is made of plastic,
the vessel includes a lid enabling to adjust the immersion level of the means for injecting vapour-phased water in the gas,
the inlet and outlet doors are connectors,
the vessel contains de-ionised liquid water,
the vessel contains distilled liquid water.

The humidifier as described previously may advantageously be used for atomic emission spectrometry, in particular ICP-type spectrometry, and also for other types of spectrometry such as atomic absorption spectrometry.

The invention will be described more in detail with reference to the appended drawings wherein:

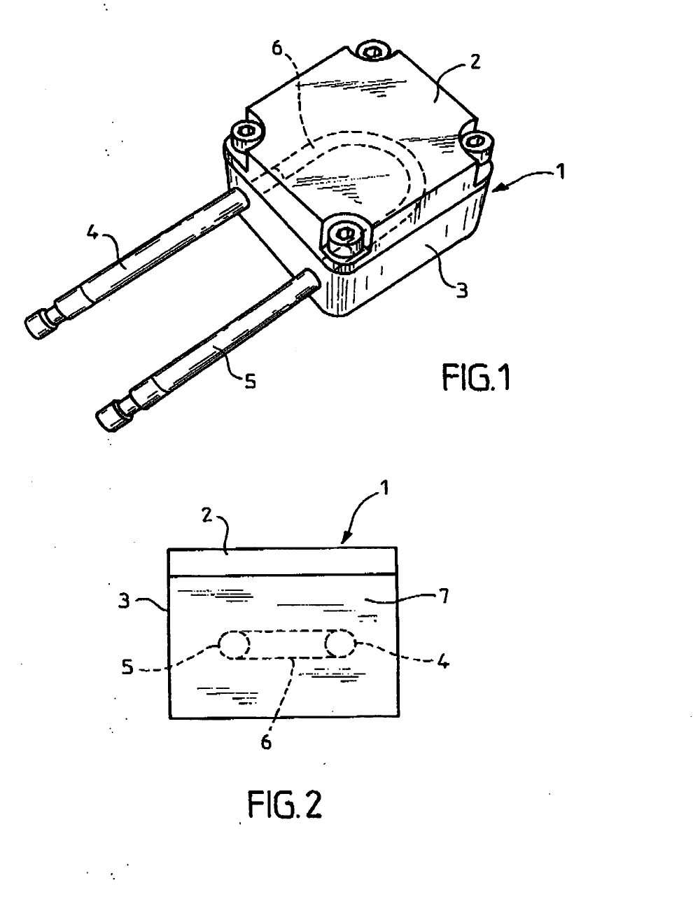

FIG. 1 is a schematic representation of the humidifier according to an embodiment of the invention;

FIG. 2 is a rear face view of the humidifier of FIG. 1.

One of the decisive conditions for the quality of an emission spectrometry analysis is the way whereof the analyte is introduced in the excitation device. For instance, the introduction of droplets in the excitation device should be avoided, which may cause certain Instability in the emission spectrum. Thus, for an ICP-type excitation device, it is essential that humidification of the plasma carrier gas, typically Argon, is obtained without any formation of droplets. The humidifier therefore comprises means for injecting vapour-phased water in the gas, which enables to eliminate any possibility of formation of said droplets.

FIG. 1 represents schematically a humidifier according to a particular embodiment of the invention. The humidifier includes a vessel 1 intended for containing liquid water which may be de-ionised and/or distilled or other . . . Preferably, this vessel 1 contains a lid 2 covering the wall 3 of said vessel 1 to close said vessel. The liquid losses during the manipulation of the humidifier for its connection to or disconnection from the nebulizer are thereby avoided. This lid 2 may be removable or not and in the former case, it may then be attached by screwing.

The humidifier also contains an inlet door 4 for injecting gas in the vessel 1 and an outlet door 5 for the gas of said vessel. The inlet door 4 for the introduction of the gas is, generally, connected to a source of gas enabling to supply an analysis device with dry gas, i.e. hardly humid or not at all. This inlet door 4 is for instance an inlet connector linked with a gas transfer line, itself linked with said gas source. The outlet door 5 of the gas may be also a connector to which a nebulizer for instance is connected as dose as possible.

Advantageously, the vessel 1 as well as the inlet 4 and outlet 5 doors form a single part obtained directly by moulding. This monobloc part is for instance made of plastic.

One obtains thus, at low cost, since it is made almost in a single moulding operation, a humidifier which may be connected in series to the analysis device. It suffices in fact to adjoin thereto, simply, means for injecting vapour-phased water 6 to complement the humidification device. The monobloc humidifier thus obtained is compact and easy of manipulation (manually or directly via an automated machine element) without risking any disassembly of its constitutive parts and with very low risks of damage in case of fall or untimely shocks.

The humidifier thus realised may carry advantageously an individual identification mark enabling to determine the nature of the liquid water 7 intended to be contained in the vessel (distilled, deionised, . . . ).

In other embodiments, the monobloc part is made of stainless steel or Teflon-coated stainless steel, or other.

The means for injecting vapour-phased water 6 wherein the humidifier gas flow, comprise a diaphragm. This diaphragm has a wall in contact on one side with the liquid water 7 and on the other with the gas (FIG. 2). The diaphragm 6 may form the wall of a hollow tube or of a hollow spiral. But it is not limited, however, to these examples and may take on any other shape enabling circulation of the gas to be humidified inside said diaphragm and offering externally a contact surface with the liquid water 7. Typically, during the introduction of the gas in the diaphragm at least partially immersed in the liquid water 7, the water molecules which are adsorbed on the internal wall of the diaphragm, i.e. in contact with the gas, are released very quickly in the flux of the gas and driven therewith. The gas is thus humidified. The diaphragm is for instance made of modified Teflon.

The gas to be humidified is introduced through the inlet door 4 of the vessel 1 in the means for injecting vapour-phased water 6 and the humidified gas is received at output at the outlet door 5 of the humidifier. The means for injecting vapour-phased water 6 in the gas comprise a diaphragm at least partially immersed and preferably, totally immersed in the liquid water 7. The vessel 1 enables advantageously the operator to access said means 6 to vary the immersion level of the diaphragm in the liquid water 7 thus varying the interaction surface between the gas in circulation and the wall of the diaphragm in contact with said gas. The humidity ratio of the gas is thus varied. This ratio depends obviously on other parameters such as the pressure of the gas inside the means for injecting vapour phased water 6.

The typical dimensions of the vessel 1 to contain liquid water 7 are in a particular embodiment 80×80×60 (mm). The dimensions of the wall of the tube are then 250 mm in length and 3 mm in diameter. These dimensions enable advantageously in an embodiment to obtain a humidification ratio close to 90% in the case of an Argon flux of one litre per minute for an ICP-type atomic emission spectrometer.

1. Gas humidifier including a liquid water vessel (1), an inlet door (4) for injecting gas in the vessel (1) and an outlet door (5) for the gas in the vessel, characterised in that it comprises means for injecting vapour-phased water (6) in the gas, the gas flowing through said means (6), said means (6) containing a diaphragm at least partially immersed in

2. A humidifier according to claim 1, characterised in that said diaphragm is the wall of a tube connected to the inlet (4) and outlet (5) doors.

3. A humidifier according to claim 1, characterised in that said diaphragm is the wall of a spiral connected to the inlet (4) and outlet (5) doors.

4. A humidifier according to claim 1, characterised in that the vessel (1) and the inlet (4) and outlet (5) doors form a single monobloc part obtained directly by moulding.

5. A humidifier according to claim 4, characterised in that said monobloc part is made of plastic.

6. A humidifier according to claim 1, characterised in that the vessel (1) includes a lid (2) enabling to adjust the immersion level of the means for injecting vapour-phased water (6) in the gas.

7. A humidifier according to claim 1, characterised in that the inlet (4) and outlet (5) doors are connectors.

8. A humidifier according to claim 1, characterised in that the vessel includes de-ionised liquid water (7).

9. A humidifier according to claim 1, characterised in that the vessel includes distilled liquid water (7).

10. A use of the humidifier according to claim 1, for atomic emission spectrometry.
